(19) United States
(12) Patent Application Publication
(10) Pub. No.: US 2026/0054256 A1
(43) Pub. Date: Feb. 26, 2026

(54) Catalyst, Catalyst Precursor, Production Process, and Resulting High Purity and Controlled Morphology Carbon Nanotubes

(71) Applicant: Chasm Advanced Materials, Inc., Canton, MA (US)

(72) Inventors: Ricardo A. Prada Silvy, Norman, OK (US); Sathish Kumar Lageshetty, Edmond, OK (US); Dennis McAlister, El Reno, OK (US); David J. Arthur, Braintree, MA (US)

(73) Assignee: Chasm Advanced Materials, Inc., Canton, MA (US)

(21) Appl. No.: 19/301,553

(22) Filed: Aug. 15, 2025

Related U.S. Application Data
(63) Continuation of application No. PCT/US2024/016439, filed on Feb. 20, 2024.
(60) Provisional application No. 63/446,647, filed on Feb. 17, 2023.

(51) Int. Cl. B01J 23/75; B01J 21/04; B01J 35/61; B01J 35/63; B01J 37/12; C01B 32/162

(52) U.S. Cl. CPC B01J 23/75; B01J 21/04; B01J 35/615; B01J 35/633; B01J 37/12; C01B 32/162; C01B 2202/06; C01B 2202/32; C01B 2202/34; C01B 2202/36; C01P 2002/82; C01P 2004/03; C01P 2006/10; C01P 2006/12; C01P 2006/14

(57) ABSTRACT

A catalyst, catalyst precursor, and carbon nanotubes grown using the catalyst. The catalyst includes a support comprising alumina and a cobalt species on a surface of the support, wherein cobalt is the sole active catalyst species for carbon nanotube growth. The support surface is iron-free.

### CROSS-REFERENCE TO RELATED APPLICATIONS

This application is a Continuation of PCT/US2024/016439, filed on Feb. 20, 2024, which itself claimed priority of Provisional Application 63/446,647 filed on Feb. 17, 2023. The entire disclosure of the priority applications are incorporated by reference herein for all purposes.

### BACKGROUND

This disclosure relates to carbon nanotubes (CNT) and catalysts for producing CNT.

There are a large number of commercial applications that take full advantage of CNT material properties due to their unique structure and morphology characteristics, electrical and thermal conductivity capacity and mechanical properties. Examples of these applications are energy storage where CNTs have been demonstrated to have great potential as anode and cathode materials and as conductive additives for lithium-ion batteries (LiBs). The measured reversible lithium-ion capacities of CNT-based electrodes are considerably improved compared to conventional graphite-based anodes. The capacity of LiBs based on graphite as an anode material is limited since lithium ions can only combine with every second carbon hexagon in the graphite sheets. The intercalation of lithium into graphite involves one lithium atom per six carbon atoms, i.e., LiC₆, leading to a limited specific capacity of 372 mAh/g and an observed capacity of 280-330 mAh/g, depending on the type of graphite used. Carbon nanotubes have been reported to show much improved Li capacity compared to graphite, due to their tubular carbon structures and properties.

There are two types of carbon nanotubes, single walled (SWCNT) and multiwalled carbon nanotubes (MWCNT). These CNT materials have conductivities as high as 10⁶ S/m and 10⁵ S/m respectively, tensile strength of 63 GPa, and Young's modulus of about 1.2 TPa. These properties make CNTs one of the strongest and stiffest conductive materials. The inner and outer diameter of the tubes is an important parameter of the structure of CNTs and can affect lithium adsorption capacity and diffusion, both inside and outside the CNTs. Li-ions intercalated into CNTs will interact with CNTs, and the charge transfer between CNTs and lithium ions will further enhance these interactions. The interaction is related to the curvature of the tubes and will result in different lithium capacities in CNTs. Exfoliation from MWCNTs during electrochemical insertion of lithium is also dependent on the inner diameter of the tubes and will consequently influence lithium capacities as well, although it was found that intercalated Li/Li⁺ prefers to localize near the CNT sidewall, instead of being located at the tube center. Therefore, very large diameter MWCNTs, which have useless space inside, will be at a disadvantage compared with the small diameter ones when used for batteries. With an increase in tube diameter, the intercalated lithium atoms tend to form a multi-shell structure at the equilibrium state, composed of coaxial tubes with a linear chain in the axis, which will improve lithium capacity. Other research shows that CNTs with a diameter higher than 5 Å have greater interaction energy, thus making them the best candidate for lithium storage as an anode material of LIBs. In sum, a very large MWCNT diameter has disadvantages compared to a smaller diameter because there are available spaces that are not occupied to retain lithium. It is also likely that there is an optimal number of walls that corresponds to greater lithium retention between the layers. It is believed that there is an optimal outer diameter for MWCNT that provides higher electrical conductivity. It has been observed that MWCNTs with a diameter larger than 15 nm are less conductive. The number of concentric tubes for an outer diameter of 15 nm and an inner diameter of 2.5 nm is around 13.

The length of CNTs is another important morphological factor that is able to influence the lithium-ion diffusion of CNTs. It has been observed that short MWCNTs provide short reversible routes for Li ions and additional intercalation sites at abundant open ends for Li ion storage. In practice, chemical and ball milling treatments are extensively used to increase lithium insertion and the reversible capacity. However, chemical treatments reduce the coulombic efficiency because the introduction of large structure defects, while ball milling treatment will result in a large voltage hysteresis because of the amount of surface functional groups formed on CNTs.

The use of CNTs as conductive additives in Li-ion battery cathodes has demonstrated a distinctive choice for improving electrochemical properties. The high aspect ratio of CNTs (L/D) compared to the other carbon additives allows for lower loading levels to achieve a comparable percolation threshold. Accordingly, the conductivity and electrochemical properties of the electrodes can be improved at a smaller amount of CNTs, leading to a higher energy capacity, power density and longer charge and discharge cycles for the electrode.

CNTs also have remarkable thermal conductivity properties that can promote effective heat dissipation within a composite, potentially enhancing the safety over composite electrodes with inferior carbon additives. In addition, the mechanical properties of CNTs exhibit both strength and flexibility. These are both attractive features to prevent cracking during operation or in vibration environments. Also, the ability to entangle anode and cathode particles using CNTs can obviate issues of active particle separation with extended cycling.

The high purity of carbon nanotubes is another parameter for increasing the performance of LIBs. It was found that the presence of certain impurities, for instance metal ions such as iron, sodium, aluminum and nickel, and substances containing active hydrogen in electrolyte molecules, can mitigate the electrochemical performance of the batteries. Some metal impurity ions have a lower reduction potential than lithium ions. Therefore, during charging, metal impurity ions will first be embedded in the carbon negative electrode, reducing the insertion position of lithium ions, thus reducing the reversible capacity of lithium-ion batteries. Deposits of iron accelerate the decomposition of the electrolyte and aggravate surface structural disorder in graphite, resulting in the formation of thicker solid-electrolyte interface (SEI) film leading to an increase of interfacial impedance of graphite electrodes. These effects cause capacity fading upon cycling. A high concentration of metal impurity ions will not only lead to a decrease of the reversible specific capacity of lithium-ion batteries, but also the precipitation of metal impurity ions may lead to the failure to form an effective passivation layer on the surface of graphite electrodes and destroy the whole battery. Therefore, it is generally recognized that the content of each metal impurity ion in the organic electrolyte should be less than about 0.007 wt %.

Despite the high energy capacity of LIBs, there are many challenges in the development of a new generation of LIBs, including improving the charging capacity rate, lowering battery weight and size, and increasing cycle life of the electrode materials. There is the need to develop CNTs materials having controlled structure and morphology and high purity properties to improve the performance of conventional materials. At present, there is a clear advantage for using CNTs in LIBs as an additive within composite electrodes to increase the reversible capacity, enhance the rate capability, and improve cyclability.

### SUMMARY

Aspects and examples are directed to catalyst precursors, catalysts, methods of preparing them, and CNT compositions and purified CNT compositions.

This disclosure is related to a method for preparing heterogeneous catalysts with a large specific surface area and low active phase composition in comparison with the prior art that enables, in a short reaction time, high yields of carbon nanotubes having high purity and selectivity to tubular carbon, high surface area and aspect ratio (L/D). A process for the manufacture of these carbon nanotubes using different catalytic reactor types is also described. The obtained nanotubes using this catalyst and manufacturing process are desirable for various industrial applications, particularly for those where carbon nanotubes having controlled morphology (inner and outer diameter distribution, length, number of walls and bundle size), and very high purity are specially required, in particular for Li-ion battery electrodes, super capacitors, CNT membranes, printed electronics, composites, etc.

The catalyst preparation for the desired CNTs includes the following consecutive steps: a) contact an aqueous solution containing metallic salts of the active components with aluminum hydroxides (e.g., boehmite, gibbsite, bayerite, aluminum alkoxides), using conventional impregnation techniques (pore volume, ionic exchange, mixing in a high-speed mixer); b) form a paste or granules of the impregnated material and submit to aging under controlled humidity and temperature for about 2 hours; c) dry the impregnated material in the presence of air-flow at temperature between 25° C., 60° C. and 120° C.; d) sieve the material to a particle size between 30 to 500 microns, according to the type of reactor to be used; and e) calcine the catalyst powder in an oven in the presence of nitrogen or air and nitrogen flow at a temperature between 350° C. and 550° C. The active metal composition is tuned in order to control the CNT morphology and yield. For example, the composition of the active metal on the support surface can be optimized to control the size of the active phase nanoparticles on the surface and their density. The size of the nanoparticles controls the diameter of the tubes, and their density and surface composition control the CNT morphology.

When the method of catalyst preparation by ionic exchange is employed, an excess of metallic solution (about 3 to 6 times greater than the porous volume of the catalyst support) is contacted with the support in a closed vessel provided with a reflux system. The ionic exchange is carried out at 45-75° C. temperature range for several hours (t≥2 hr.). The liquid is separated from the solid by a filtration technique. The formed paste is dried and subsequently sieved and calcined according to the protocol described above.

Various types of carbon nanotubes (single wall, double wall or multiple wall) can be obtained using different catalyst compositions, carbon sources (CO, CH₄, C₂H₂, C₂H₄, C₃H₆, C₂H₆, C₃H₈, C₄H₁₀, etc.), synthesis temperatures in fluidized bed or rotary tube reactors. The residual catalyst particles are removed from the CNT product by leaching treatments employing concentrated inorganic acid solutions (e.g., HF, HCl, H₂SO₄, HNO₃ and mixture of them) followed by filtration, washing with deionized water and drying. The catalyst manufacture, and processes for synthesis and purification of the CNTs of this invention, are commercially scalable.

Most of the commercial carbon nanotubes made today are synthesized using iron in combination with other active metals (Ni, Co, Mo etc.) in the catalyst formulation. Exemplary catalyst precursor and catalyst compositions and catalyst production methods are disclosed, for example, in U.S. Pat. No. 9,084,990, the disclosure of which is incorporated herein by reference in its entirety and for all purposes. As we have previously described, iron and nickel ions are elements impurities that mitigate the electrochemical performance of lithium-ion batteries by reducing the insertion of lithium ions in the anode, affecting its reversible capacity. The combination of Fe with Co or Fe with Mo provides high carbon yield catalysts in the synthesis of double-walled (DWCNT) and multiwalled carbon nanotubes. These are mainly due to the formation of oxide precursors during the calcination step; such as nanocrystals of CoFe₂O₄ and FeMoO₄, which, upon contact with the carbon source, form highly dispersed active metal nanoparticles on the surface of the catalyst support. The iron in the catalyst can exist in metallic form or forming iron carbide (Fe₃C) or a non-stoichiometric mixed phase with cobalt (CoₓFe₃₋ₓC) or molybdenum (Mo₂₋ₓFeₓC).

Iron is found in most catalysts employed for the synthesis of CNTs in higher composition than cobalt, nickel or molybdenum. During the purification step of the carbon nanotubes, strong inorganic acids are used to remove the active metals and catalyst support particles. However, metal carbides such as iron carbide are very stable, and have very low solubility in these acids (in particular iron-carbides, that is a component of stainless steel, have to be removed from the product through very high temperatures treatments under vacuum). These treatments can cause significant structural and morphology modifications (graphitization of the tubes that create defects) affecting their electrical conductivity and mechanical properties. The material results are not suitable for its use in Li-ion battery electrodes.

In the preparation of heterogeneous catalysts for the production of carbon nanotubes, it can be important to control the type and distribution of the supported metal oxides, as well as the size of active metals nanoparticles, which determines the diameter of the nanotubes and their surface dispersion. In order to solve the above limitation, the formulation of new catalysts using active metals that do not alter the electrochemical capacity of lithium batteries is required. There are no reports indicating that cobalt ions affect the electrochemical capacity of lithium batteries. In fact, cobalt is one of the key components used in the cathodes. Cobalt is used in the formulation of commercial catalysts for the production of SWCNTs and MWCNTs, so this metal can offer advantages for the production of MWCNT with controlled morphology and high purity.

A factor in the development of new catalysts is to be able to control the surface dispersion of metal nanoparticles and prevent cobalt from reacting with the aluminum-containing catalyst support to form cobalt aluminate (CoAl₂O₄ that shows a spinel-like structure), which is an inactive phase during the catalytic reaction.

This invention differs from that of the prior art in at least the following aspects: The Co/MgO—Al₂O₃ catalyst preparation method enables using a much lower amount of cobalt (at least 50 wt % lower) than in the prior art catalysts. The catalyst is prepared from aluminum hydroxide, instead of alumina, which allows a greater surface metallic dispersion. The preparation method is commercially scalable and uses fewer steps which decreases production time and costs. The catalyst leads to higher yields of carbon nanotubes in a shorter reaction time. The synthesis can be carried out in both fluidized bed and rotary tube reactors. The carbon nanotubes produced have higher aspect ratio than those available commercially. Due to lower cobalt loading in the catalyst compared to prior art, following benefits can be gained such as: a) the metal removal from the product during leaching treatment is more efficient; b) a better control of the morphology properties of the tube (uniformity, diameter distribution, bundle sizes); c) selectivity to tubular carbon; and d) improvement in the dispersibility properties. The hydrogen formed during the carbon source catalytic decomposition, can be separated using a selective membrane and then used for other industrial process or to generate power and heat. In one aspect, to inhibit the formation of cobalt aluminate during the preparation of the catalyst, in this invention we can add a cation from group II of the periodic table (such as Mg or Ca) to block the tetrahedral sites of the alumina by forming a more stable spinel-like structure. These additives lower the surface acidity of the alumina preventing the formation of non-tubular carbon species by cracking the carbon source molecules.

All examples and features mentioned below can be combined in any technically possible way.

In one aspect, a catalyst precursor composition includes a support comprising alumina, and a cobalt species on a surface of the support, wherein cobalt is the sole active catalyst species for carbon nanotube (CNT) growth.

In another aspect a catalyst composition for growing carbon nanotubes (CNT) includes an alumina support and cobalt on a surface of the support, wherein cobalt is the sole active catalyst species for CNT growth.

Some examples include one of the above and/or below features, or any combination thereof. In an example the surface of the support is iron-free. In an example the support further comprises an element from Group IIA of the periodic table. In an example the element from Group IIA of the periodic table comprises magnesium. In an example the cobalt species comprises a cobalt oxide. In an example the cobalt species comprises less than 15% by weight of the catalyst precursor. In an example the cobalt species comprises about 10% by weight of the catalyst precursor.

Some examples include one of the above and/or below features, or any combination thereof. In an example the catalyst precursor composition has a BET surface area of over 300 m²/g. In an example the catalyst precursor composition has a pore volume of at least about 0.25 cc/g.

Some examples include one of the above and/or below features, or any combination thereof. In an example the catalyst precursor composition is configured to yield at least about 85% CNT. In an example the catalyst precursor composition is configured to produce multi-wall CNTs. In an example the catalyst precursor composition is configured to produce CNT having a BET surface area of over 300 m²/g. In an example the catalyst precursor composition is configured to produce CNT having a pore volume of at least about 2 cc/g. In an example the catalyst precursor composition is configured to produce CNT having a bulk density of at least about 0.08 g/cc. In an example the catalyst precursor composition is configured to produce CNT having a diameter range of from about 8 nm to about 12 nm. In an example the catalyst precursor composition is configured to produce CNT having a G/D relative Raman intensity ratio of at least about 1.0 measured using a 638 nm laser source and about 0.9 using a 532 nm laser source. In an example the catalyst precursor composition is configured to produce CNT having lengths of at least about 10 microns.

In another aspect a method for preparing a catalyst precursor composition comprising a support comprising alumina, and a cobalt species on a surface of the support, wherein cobalt is the sole active catalyst species for carbon nanotube (CNT) growth, includes providing an aluminum hydroxide support precursor, contacting the aluminum hydroxide support precursor with a solution that comprises at least a cobalt salt to create a paste, and drying and calcining the paste to create the catalyst precursor.

Some examples include one of the above and/or below features, or any combination thereof. In an example the solution comprises a cobalt salt and a magnesium salt. In an example the aluminum hydroxide comprises one or more of gibbsite, bayerite, boehmite and those obtained by hydrolysis of aluminum alkoxides. In an example the contacting step comprises mixing the aluminum hydroxide support precursor and the solution in a mixer. In an example drying the paste comprises aging the paste at room temperature. In an example drying the paste further comprises subjecting the aged paste to an elevated temperature for a number of hours to develop a dried paste.

Some examples include one of the above and/or below features, or any combination thereof. In an example the calcining step comprises subjecting the dried paste to a temperature of at least about 400° C. for at least about 2 hours in air flow. In an example the calcining step takes place at about 450° C. In an example a Co:MgO:Al₂O₃ molar ratio composition is about 14:to about 1:to about 70, respectively. In an example the method further includes size sorting the dried paste before the calcining step. In an example the size sorting step includes developing dried solid particles of at least about 100 microns. In an example the dried solid particles are developed in a size range of from about 100 microns to about 300 microns.

In another aspect a purified carbon nanotube (CNT) composition includes at least about 99% CNT and no more than about 0.5% metal catalyst. The residual mass as determined by an ashes method is no more than about 0.80 weight %.

Some examples include one of the above and/or below features, or any combination thereof. In an example the purified CNT composition includes at least about 99.7% CNT. In an example the purified CNT composition includes no more than about 0.3% catalyst. In an example the purified CNT composition includes at least about 85% CNT before purification. In an example the purified CNT composition includes multi-wall CNTs.

Some examples include one of the above and/or below features, or any combination thereof. In an example the CNT have a BET surface area of over 300 m²/g. In an example the CNT have a pore volume of at least about 2 cc/g. In an example the CNT have a bulk density of at least about 0.08 g/cc. In an example the CNT have a diameter range of from about 8 nm to about 12 nm. In an example the CNT have a G/D relative Raman intensity ratio of at least about 1 measured using a 638 nm laser source and at least about 0.9 measured using a 532 nm laser source. In an example the CNT have lengths of at least about 10 microns. In an example at least most of the CNT have a length after synthesis and chemical purification of at least about 10 microns. In an example at least most of the CNT have a length after dispersion in the range of from about 1 micron to about 5 microns. In an example at least most of the CNT have a bulk density in the range of from about 0.06 to about 0.09 g/cc.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a schematic diagram of a prior art catalyst preparation procedure.

FIG. 2 is a schematic diagram of a catalyst preparation procedure of the present disclosure.

FIG. 3A is a Raman spectrum using 638 nm laser source for prior art CNT comprising 96.90% MWCNT.

FIGS. 3B and 3C are similar Raman spectra but for two examples of the inventive purified CNTs made using the Co/MgO—Al₂O₃ based catalyst, at two different carbon purities, 99.70% and 99.17% MWCNT, respectively.

FIG. 4A is a Raman spectrum using 532 nm laser source for the prior art CNT comprising 96.90% MWCNT reported in FIG. 3A.

FIGS. 4B and 4C are similar Raman spectra but for the two examples of the inventive purified CNTs at two different carbon purities, 99.70% and 99.17% MWCNT, respectively, as reported in FIGS. 3B and 3C.

FIGS. 5A and 5B are Raman spectra using a 532 nm laser source and a 638 nm laser source, respectively, for examples of the inventive purified CNTs made using the Co—Al₂O₃ based catalyst.

FIG. 6 includes nine SEM images. The top row is taken at 1 KX, the middle row at 5 KX and the bottom row at 25 KX. The leftmost column includes three images of CNTs of the present invention created based on a ten-minute reaction time, the middle column includes three images of CNTs of the present invention created based on a twenty-minute reaction time, and the rightmost column includes three images of CNTs of the present invention created based on a thirty-minute reaction time.

FIG. 7 is an SEM image taken at 10 K×magnification corresponding to the CNTs synthesized in the present invention and capturing the supported catalyst.

FIG. 8 is an SEM Image taken at 10K×magnification corresponding to the CNT purified sample at 99.17 wt % carbon, details of which are provided in other drawings, as indicated herein.

FIG. 9 is an SEM image taken at 10K×magnification for a purified CNT of the present invention made using the Co/Al₂O₃, catalyst.

FIG. 10 includes nine SEM images organized in the same manner as those of FIG. 6, but of prior art CNTs, wherein the top row is taken at 1 KX, the middle row at 5 KX and the bottom row at 25 KX. The leftmost column includes three images of prior art CNTs created based on a ten-minute reaction time, the middle column includes three images of prior art CNTs created based on a twenty-minute reaction time, and the rightmost column includes three images of prior art CNTs created based on a thirty-minute reaction time.

FIG. 11 illustrates the CNT length distribution in an aqueous dispersion of inventive CNTs.

### DETAILED DESCRIPTION

Examples of the materials, systems, methods and apparatuses discussed herein are not limited in application to the details of construction and the arrangement of components set forth in the following description or illustrated in the accompanying drawings. The materials, systems, methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the computer program products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

In this invention, the limitations presented above were solved by the preparation of a catalyst with a low Co loading supported on MgAl₂O₄, MgO—Al₂O₃, and processes for the use of the catalyst for the production of CNTs having high purity and controlled morphology. These CNTs are useful in energy storage and other commercial applications that require or are advantaged by these features.

Unlike the prior art, in examples herein a solution containing either a Co salt alone, or Co and Mg salts in combination, is contacted with an alumina precursor (Al(OH)₃) to form a homogeneous paste in a mixing equipment. After a certain aging time, where the Co⁺² and Mg⁺² ions are exchanged with the OH⁻ groups of the Al(OH)₃, the paste is dried at different temperatures to control the thermal decomposition of the salts. The drying stage helps to prevent the exothermic decomposition of the active metal surface dispersion that can be caused if the removal of water and the reaction of the metal salts containing nitrates or acetates are carried out faster, such as in the reactor. This excessive heat produced by the exothermic decomposition reaction of nitrates or acetates can be controlled by using air diluted with N₂ or N₂ flow during the drying stage.

The dried solid is ground and sieved to the desired particle sizes, depending on the reactor to be employed for CNTs synthesis, and subsequently, calcined at moderate temperature (e.g., 450° C.) to control the textural properties (specific surface area, pore sizes distribution, pore volume) and surface properties (surface acidity, surface charge) of the catalyst support and to prevent the active metal from reacting with the alumina of the catalyst support to form the inactive CoAl₂O₄ phase. Depending on the type of aluminum hydroxide employed (boehmite, gibbsite or bayerite), different types of transition aluminas (γ-Al₂O₃, χ-Al₂O₃ or η-Al₂O₃) can be produced after calcination at temperatures above 250° C. This is the importance of a well-controlled calcination process.

The synthesis of carbon nanotubes is carried out in a fluidized bed or rotating tube reactor at temperatures between 60° and 800° C. in the presence of a gaseous mixture of a carbon source (e.g., ethylene) and hydrogen. Ethane, propane, propylene and butane, and potentially other gaseous hydrocarbons, can also be used as carbon sources, either individually or in a desired combination. The residence time of the catalyst in the rotary tube reactor in some examples is 10 minutes compared to 30 minutes of reaction in a fluidized bed reactor in the prior art. Under these reaction conditions, carbon yields greater than 90% are obtained, conversion levels comparable to the prior art.

After removing the metals and support particles from the catalyst using inorganic acid solutions, a product whose carbon purity is greater than 99.8 wt % is obtained.

Examples include the following:

### Example 1

In this example, and as depicted in FIG. 1, a prior-art CoMo/Al₂O₃ supported catalyst was prepared according to the method described in the prior art (e.g., the patent incorporated by reference herein). Aluminum hydroxide (Al(OH)₃) was calcined at 400° C. for 4 h to obtain alumina (Al₂O₃) catalyst support. The calcined material was subsequently impregnated with a solution containing cobalt nitrate and ammonium heptamolybdate (an active metal solution). The Co:Mo:Al₂O₃ molar ratio composition of the catalyst was 5:1:15, respectively. Citric acid was added to the solution to avoid cobalt molybdate precipitation. The impregnated material was subsequently aged with stirring in a thermostatic bath for 30 minutes at 60° C. and then the excess of water was removed from the solid under vacuum to form wet cake. The drying was completed at 120° C. and then the solid was calcined at 300° C. for 4 h. The catalyst was sieved to a grain size between 100 and 300 microns to create the final catalyst.

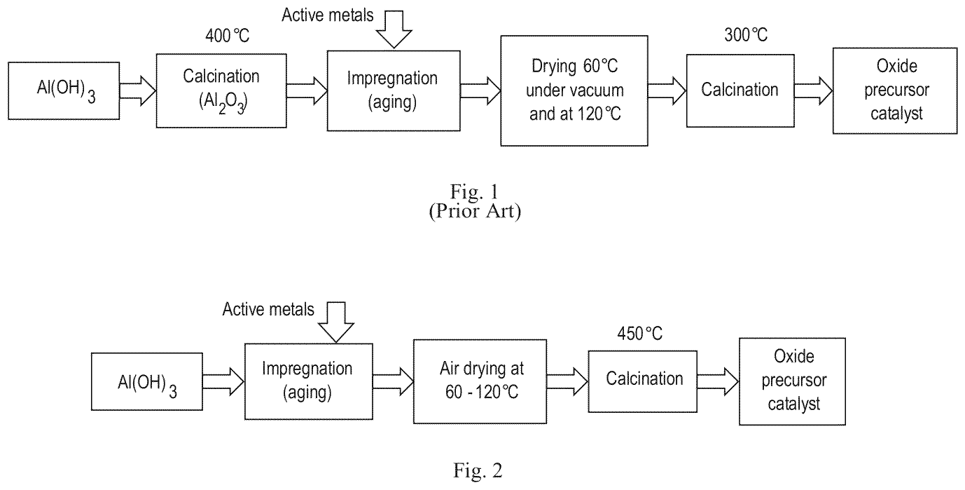

Two catalysts according to the invention were also prepared. One was based on Co/Al₂O₃ and the other on Co/MgO—Al₂O₃. These catalysts were prepared according to the following procedure, outlined in FIG. 2. For the first catalyst, a solution containing cobalt nitrate was contacted with Al(OH)₃ in a mixer to form a paste. In the second catalyst, a magnesium nitrate salt was added to the cobalt nitrate solution. The Co, MgO and Al₂O₃ molar composition (Co:Al₂O₃ and Co:MgO:Al₂O₃) in the catalysts are 14:70 and 14:1:70, respectively. The impregnated materials were subsequently aged at room temperature for 2 hr., subsequently dried at 60° C. for 3 hours and finally at 120° C. for 2 hours in air flow. The dried solid particles were sieved to a grain size between 100 and 300 microns and calcined in air flow at 450° C. for 3 h to create the final catalyst.

These catalysts were used in the synthesis of carbon nanotubes carried out in a fluidized bed reactor (FBR) and in a rotary tube reactor (RR) under the following conditions:

For the fluidized bed reactor, the process gas contained 80 v % ethylene and 20 v % of H₂, a space velocity (WHSV) of 180 L C₂H₄/g. catalyst hour, a reaction temperature of 675° C. and reaction time of 10, 20 and 30 minutes.

For the rotary tube reactor, the process gas contained 60 v % ethylene, 20 v % H₂ and 20 v % N₂, the catalyst residence time in the reaction zone was about 10 minutes and the ethylene flow/catalyst feed ratio was 3 liters/gram.

Table 1 includes the results of the synthesis of the CNTs carried out in a fluidized bed reactor (FBR) at different reaction times for the prior art catalyst and both Co/Al₂O₃ and Co/MgO—Al₂O₃ prepared catalysts, all as described above. It is observed that the ethylene conversion increases progressively with the reaction time. The catalysts prepared according to the method of the present invention show the highest MWCNT yield, despite the fact that the active phase composition is 5 wt % lower in the catalyst prepared in the present invention, as described below. The maximum MWCNT content reached for the catalyst of the present invention is 94.2 wt % for the Co/MgO—Al₂O₃ catalyst and 96.4 wt % for the Co/Al₂O₃ catalyst, which corresponds to a CNT/catalyst productivity ratio of about 16.2 and 17.9, respectively.

The same Table reports the result of the MWCNT yield obtained after 10 minutes of reaction in the rotating tube reactor (RR) for the Co/MgO—Al₂O₃ catalyst of the present invention. It is observed that the MWCNT yield obtained in rotary reactor is lower than that of fluidized bed reactor (88.4 wt % vs 92.0 wt %). This is mainly due to the existence of a better heat and mass transfer and an optimal contact between the ethylene molecules and the active surface of the catalyst in the fluidized bed reactor. However, this catalyst is much more active than that of the prior art, which showed a MWCNT yield of only 75.5 wt %.

TABLE 1
Effect of the reaction time on the MWCNT yield

| Catalyst | 7 minutes | 10 minutes | 20 minutes | 30 minutes |
|---|---|---|---|---|
| Prior art (FBR) | — | 75.5 wt % | 78.2 wt % | 81.1 wt % |
| Present invention (FBR) | 89 wt % | 92.0 wt % | 93.4 wt % | 94.2 wt % |
| Co/MgO—Al₂O₃ | | | | |
| Present invention (RR) | — | 88.4 wt % | — | — |
| Co/MgO—Al₂O₃ | | | | |
| Present invention (FBR) Co/Al₂O₃ | — | — | 96.4 wt % | — |

### Example 2: Properties of the Catalysts

In this example are compared the textural properties of the alumina support and the prepared cobalt supported catalysts (Table 2). The surface area of the aluminum hydroxide used for the synthesis of the alumina and the catalyst is about 5 m²/g. When the Al(OH)₃ was calcined at 400° C. to form Al₂O₃, the specific surface area increased to about 369 m²/g and the pore volume to about 0.29 cc/g. The average pore diameter was 27 A°. For the prior art catalyst preparation, when the active metals were deposited on the Al₂O₃ surface, both specific surface area and pore volume decreased to about 267 m²/g and about 0.22 cc/g, respectively. However, the catalyst of the present invention shows a surface area and pore volume comparable to that of Al₂O₃ support (348 m²/g and 0.27 cc/g) and a lower cobalt content than the catalyst of the prior art (about 33% less cobalt). In spite of the lower active phase composition of the present invention catalyst its MWCNT yield is significantly higher.

TABLE 2
Textural and active metal composition of the different catalysts

| | BET | Pore | | | | |
|---|---|---|---|---|---|---|
| | S.A | volume | Co | Mo | MgO | Al₂O₃ |
| Catalyst | (m²/g) | (cc/g) | (wt %) | (wt %) | (wt %) | (wt %) |
| Al₂O₃ | 369 | 0.29 | — | | | |
| Catalyst | 267 | 0.22 | 15.3 | 5.0 | — | 79.7 |
| prior art | | | | | | |
| Catalyst | 348 | 0.27 | 10.3 | — | 0.50 | 89.2 |
| present | | | | | | |
| invention | | | | | | |
| Catalyst | | | 10.0 | — | — | 90.0 |
| present | | | | | | |
| invention | | | | | | |

### Example 3: Properties of the MWCNT Purified Materials

To compare the intrinsic properties of the carbon nanotubes syntheses, the CNTs samples obtained after 30 minutes reaction time were subjected to a chemical purification treatment. An acid solution containing 22.5% v of HF was used to digest the catalyst particles. This treatment was carried out overnight at room temperature under stirring. The solid was then separated from the HF acid solution by vacuum filtration. The purified CNTs were washed with abundant deionized water several times until reaching a neutral pH and subsequently dried using a freeze-dryer.

The characterization results of these purified carbon nanotubes samples are shown in Table 3. The CNT sample corresponding to the prior art has a carbon purity of approximately 96.84 wt % (i.e., a residual metal content of about 3.16 wt %), while the residual metal in the CNTs synthesized using the catalysts of the present invention was about one tenth of this, or between 0.30-0.35 wt %, which represent a significantly greater carbon purity of about 99.65-99.70 wt %. The specific surface area (BET S.A.) results obtained for the CNTs purified samples show slight differences vs. the values obtained for the catalysts used in the prior art and in the present invention (264 m²/g vs 267 m²/g and 337 m²/g vs 348 m²/g, respectively). However, the pore volume of the purified samples increased significantly vs. the values observed for their respective catalysts. The greatest increase in pore volume was observed for the CNT synthesized with the catalyst of the present invention (2.5 cc/g for the present invention vs 0.92 cc/g for the prior art). The tap bulk density value is lower for the prior art CNTs (0.056 g/cc). Scanning electron microscopy analyzes (SEM) revealed that both purified carbon nanotubes have external diameters between 10 and 14 nm for the prior art and between 8-12 nm for the present invention. The conductivity properties of the purified samples were determined via surface resistivity measurements using a 4-probe electrode. The results of Table 3 clearly show the higher conductivity of the CNTs synthesized with the catalyst of the present invention. It should be noted that the CNT content was kept the same during the sample preparation for surface resistivity measurements, since there are differences in carbon purity between both samples, the amounts of material used for their preparation have to be normalized.

TABLE 3
Characterization results of carbon nanotubes (after purification)

| | Residual | BET | Pore | Bulk | | Electrical |
|---|---|---|---|---|---|---|
| | metal | S.A | volume | density | CNT | resistivity |
| | (wt %) | (m²/g) | (cc/g) | (g/cc) | Diameter | (Ω/□) |
| Prior art | 3.16 | 264 | 0.92 | 0.056 | 10-14 | 1566 |
| Present | 0.30 | 337 | 2.5 | 0.087 | 8-12 | 1287 |
| invention | | | | | | |
| Co/MgO—Al₂O₃ | | | | | | |
| Present | 0.83 | 329 | 2.4 | 0.062 | 9-12 | 906 |
| Invention | | | | | | |
| Co/MgO—Al₂O₃ | | | | | | |
| Present | 0.35 | 339 | 2.4 | 0.066 | 8-12 | 1271 |
| Invention | | | | | | |
| Co/Al₂O₃ | | | | | | |

### Raman Spectra:

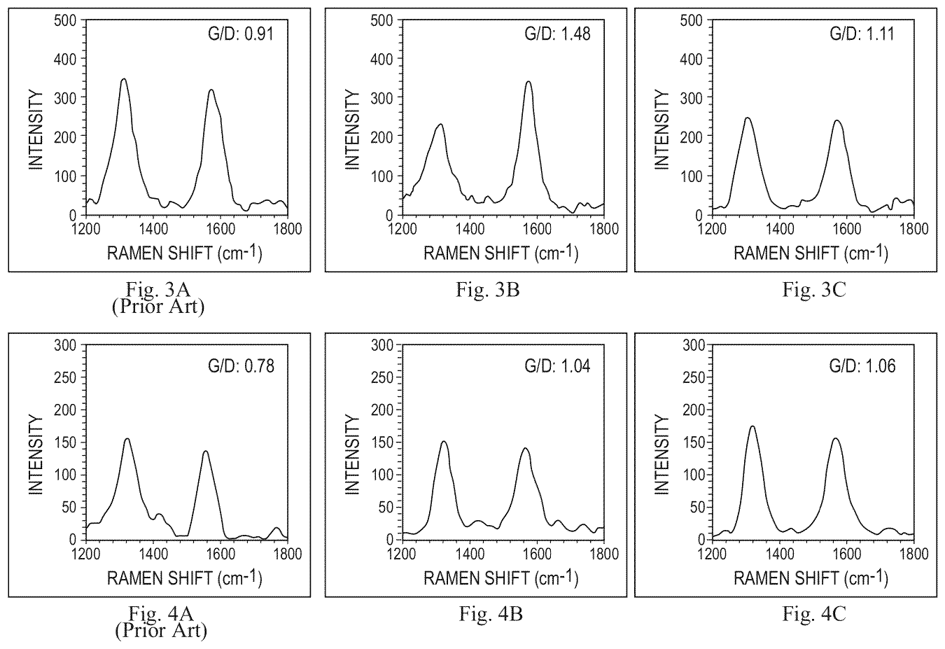

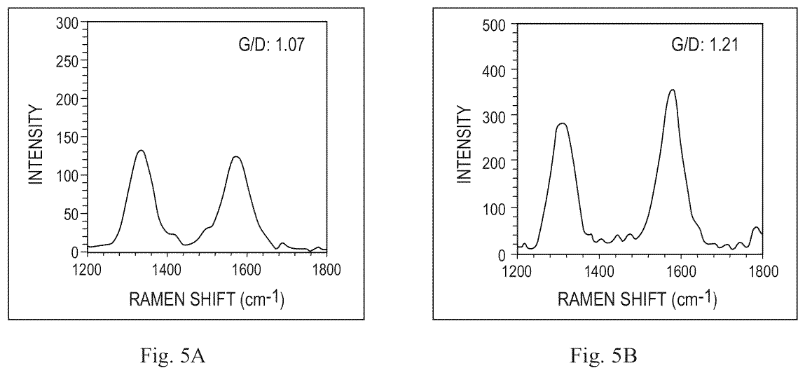

Raman spectroscopy is a useful technique for carbon nanotube characterization which enable the determination of the purity of tubular carbon species and their number of structural defects through the G/D relative intensities determination. Analysis was conducted using both the 532 and 638 nm laser sources. The D-band located at approximately 1350 cm-1 is attributed to the presence of amorphous carbon and/or structural defects in the carbon nanotubes while the G-band, located at approximately 1585 cm-1, corresponds to tubular carbon. The G/D ratios values obtained using 532 nm laser source were lower compared to the values obtained using 638 nm laser source. FIGS. 3A-3C (using 638 nm laser source) and FIGS. 4A-4C (using 532 nm laser source) shows the Raman spectra corresponding to the CNTs purified samples of the prior art and that of the present invention obtained with the Co/MgO—Al₂O₃ catalyst. It is clearly observed that the G/D ratio is higher in the sample of the present invention when analyzed by both the laser sources, which implies that the CNTs have higher purity in tubular carbon and/or fewer structural defects. FIGS. 5A and 5B illustrate the Raman spectra corresponding to a purified CNT sample obtained with the Co/Al₂O₃ catalyst. The G/D ratio value using the 532 nm laser is similar to those obtained CNTs obtained using the Co/MgO—Al₂O₃ catalyst. Using the 638 nm laser, the obtained G/D ratio value is significantly higher than the CNTs purified product of prior art.

ICP (inductively coupled plasma) spectroscopy analysis is a useful technique for analyzing the chemical composition of the materials. Analysis was conducted on a sample that contained 99.70 wt % MWCNT and the results showed that total metal content was less than 2000 ppm, with almost 1814 ppm (approx. 90%) of this metal being Co. Table 4 provides a more complete description of metals observed in the sample:

TABLE 4
ICP results of the purified carbon nanotubes sample
obtained with the Co/MgO—Al₂O₃ catalyst.

| | | | | Other metal |
|---|---|---|---|---|
| Metal | Al | Co | Mg | impurities |
| ppm | 12 | 1814 | 2.31 | 105.3 |

### Example 4: Morphology Properties of the CNTs

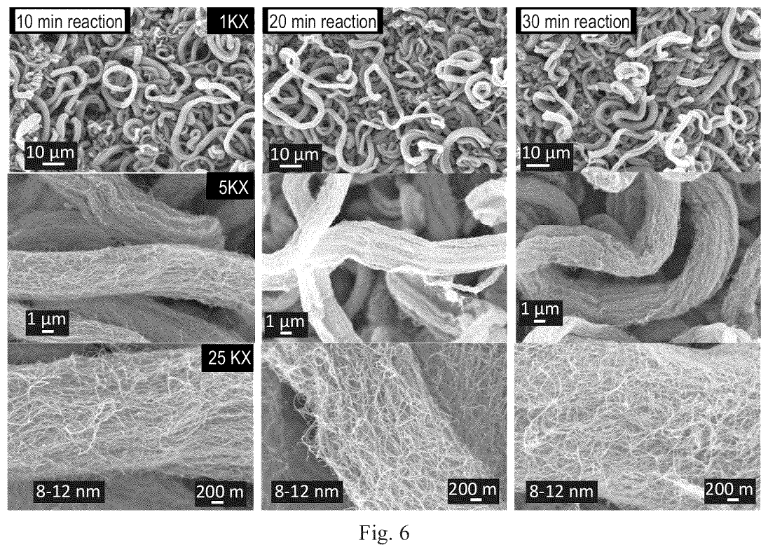

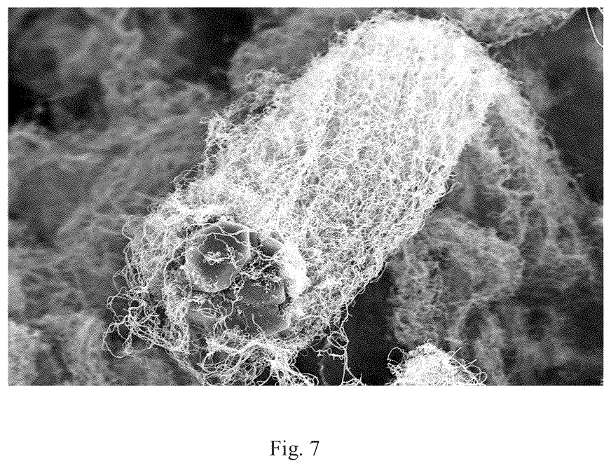

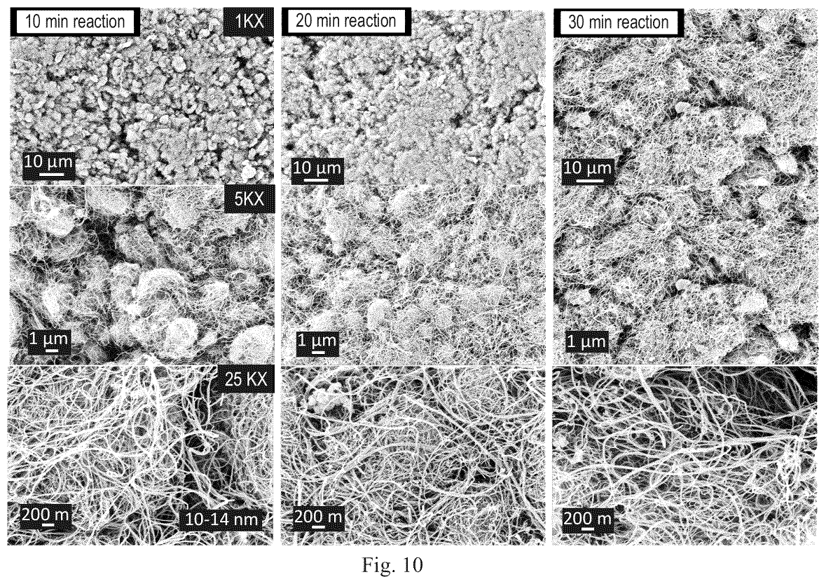

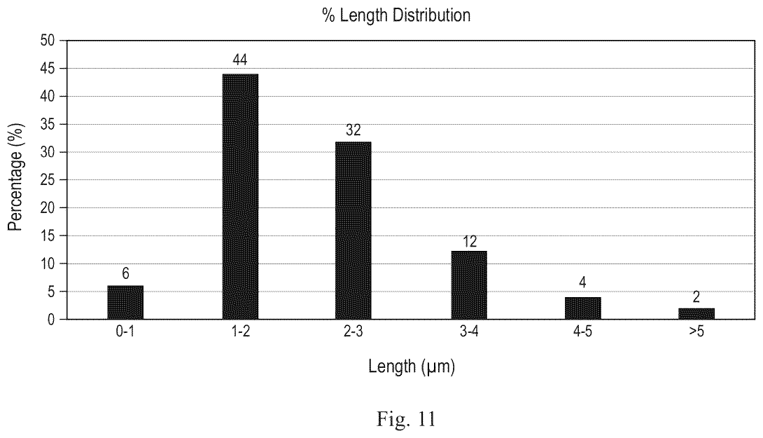

In this example, the CNTs synthesized with the Co/MgO—Al₂O₃ catalyst at different reaction times in Example 1 were analyzed by the Scanning Electron Microscopy (SEM) technique in order to investigate their morphological properties. FIG. 6 includes the SEM images obtained at 1 KX, 5 KX, and 25 K×magnification corresponding to the CNTs obtained in the present invention, while FIG. 10 provides the same for CNTs obtained using the prior art catalyst described above. Differences in morphological properties of the CNTS are clearly observed. The carbon nanotubes of the present invention form long rods-like structures whose lengths are greater than 10 microns and the CNT diameter varies between 8 to 12 nm. As the reaction time increases from 10 minutes to 30 minutes these rods get longer but the diameter of the CNTs do not change (FIG. 6).

FIG. 7 shows an SEM image taken at 10 K×magnification of the CNTs synthesized in the present invention. It shows the growth of MWCNTs rods on a catalyst particle.

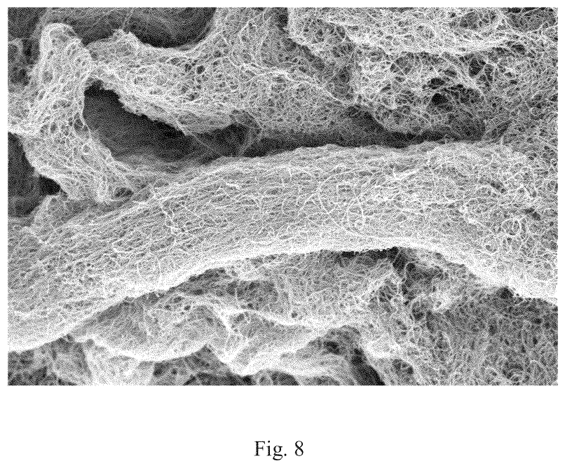

FIG. 8 shows SEM images corresponding to MWCNT purified samples where no residual catalyst particles are visible and the tubes preserve the same morphology before and after purification.

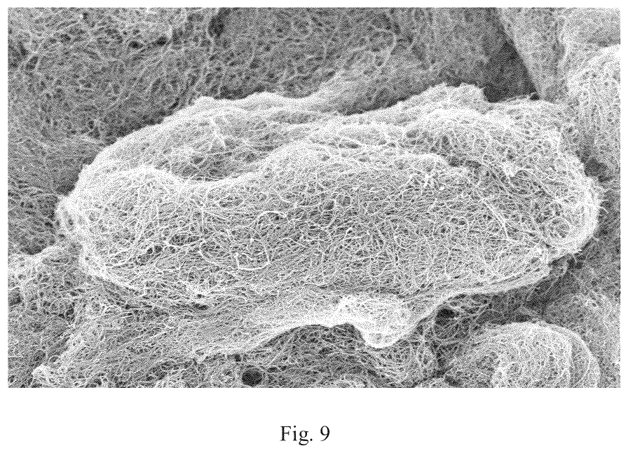

FIG. 9 shows an SEM image taken at 10 K×magnification of the inventive CNTs synthesized with the Co/Al₂O₃ catalyst. The morphology looked similar compared to the CNTs synthesized using the Co/MgO—Al₂O₃ catalyst.

The carbon nanotubes synthesized according to the prior art show agglomerated cotton ball-like structures (FIG. 10). The tubes are short (<10 microns) and their diameter varies between 10 and 14 nm. These differences in CNT morphology may influence the dispersibility and electrical conductivity properties that are important for the Li-ion battery electrode fabrication.

### Example 5: Method for Dispersing Carbon Nanotubes

An aqueous dispersion of purified CNTs was prepared using polyvinylpyrrolidone (PVP), and N-methy-2-pyrrolidone (NMP) as dispersing agents and their composition is shown in Table 5.

TABLE 5
Composition of the CNT dispersion in the present invention

| Formulation | CNTs | PVP | NMP | Total Solids |
|---|---|---|---|---|
| Composition | 1.53 | 1.52 | 96.95 | 3.05 |
| (wt %) | | | | |

The procedure for preparing the CNT dispersion was as follows:
1) Weigh a desired quantity of purified CNTs and PVP stock (9.1 wt % PVP in NMP) solution in a cup,
2) Apply high speed mixer and mill, with paste composition being 6.26 wt % purified CNTs, 6.24 wt % PVP and 87.49% NMP,
3) Dilute further with NMP to obtain a final composition of 1.53 wt % purified CNTs, 1.52 wt % PVP and 96.95 wt % NMP, and
4) Sonicate the above solution using 8600 kJ/L energy.

The viscosity of the prepared CNT dispersion is about 3800 cps. Testing of the prepared CNT dispersion using a Hegman gauge indicates a uniform particle size distribution.

SEM analysis was employed to determine the CNT morphology properties in the dispersion. The CNT dispersion was diluted with DI water to analyze individual CNTs and then this diluted sample was vacuum filtered on a polycarbonate or alumina filter and rinsed several times with water and alcohol to remove residual dispersing agents. A total of about 50 measurements were made at several spots on the filter for determining the length of dispersed CNTs. The results of the length distribution analysis are shown in FIG. 11 and described below.

As the SEM images of FIGS. 6 and 7 (as produced) and FIG. 8 (purified) show, the length of the tubes after synthesis and purification is longer than 10 microns. However, SEM images of the CNTs after dispersion preparation shows length distribution almost entirely in the 1 to 5 microns range.

During dispersion, the CNTs are disentangled, which can result in breakage. If the tubes are long enough to begin with (as is the case here) and disentangled enough to begin with (as is the case here), then it is possible to make a dispersion comprising individualized CNTs that have an average length of at least about 1 micron (such as here, where the lengths are about 2 microns on average). Note that, assuming the CNTs are well-dispersed, that longer average length is desired, as this lowers the percolation threshold for the CNT electrically conductive network (i.e., it takes a lower loading of CNTs to achieve a low electrical resistivity network). Note also, however, that it may be best to ensure that there are relatively few CNTs in the dispersion that are greater than about 5 microns in length. The reason for this is to minimize toxicity of the CNTs. In the unlikely event that CNTs were inhaled into the lungs, then CNTs with length greater than about 5 microns are not easily ingested by macrophages that clear debris out of lungs. The present example clearly shows a dispersion with average length greater than about 1 micron, with negligible fraction being greater than about 5 microns.

The CNT produced using the catalysts of this disclosure are well suited for use in LiB. For one, the CNT are iron-free. Iron is the source of many problems in LiB. Battery producers prefer conductive carbon materials without iron. Also the metal loading levels of the purified CNT (primarily Co, or Co and Mg) is extremely low, in the range of 2,000 ppm (see Table 4), most of which is Co (1814 ppm).

Typically, ‘as produced’ CNT products contain about 90 wt % carbon and about 10% supported catalyst. The present catalyst support is typically comprised of either alumina or magnesium oxide/alumina. Typically, the catalyst support represents more than 90 wt % of the supported catalyst, so the cobalt metal represents less than 10 wt % of the supported catalyst and less than 1 wt % of the as-produced products. Importantly, the overwhelming majority of the cobalt metal ends up being an active catalyst site. Any active sites end up nucleating the growth of CNTs and get fully encapsulated by carbon during CNT synthesis. Based on the high CNT yield and amount of cobalt in the catalyst composition, it is expected that at least 80% of the cobalt metal ends up being an active catalyst site. Thus, less than about 20 wt % of the cobalt ends up not being encapsulated by carbon. During chemical purification, essentially 100% of the catalyst support is removed, leaving a purified CNT products composition with greater than about 99.5 wt % carbon. Consistent with this, ICP analysis shows that cobalt content in purified CNT products is about 1814 ppm or 0.18 wt %. If only 20 wt % of this cobalt was ‘inactive’ and therefore was not encapsulated by carbon, then this represents 0.036 wt %. Typical conductive CNT additive loadings in cathodes or anodes of LiB are expected to be about 0.5 wt % or less. Thus, the cobalt impurity that is not encapsulated by carbon will be less than about (0.036%×0.5%)=0.00018 wt % or less than about 1.8 ppm of the electrode weight. This level of non-encapsulated cobalt impurity is not expected to be of concern to battery cell producers and battery industry experts. Also, Co is already present in LiBs, and so is generally a benign element present in conductive carbon (CNT) used in cathodes and anodes.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A catalyst composition for growing carbon nanotubes (CNT), comprising:
an alumina support; and
a cobalt species on a surface of the support, wherein the cobalt species is the sole active catalyst species for CNT growth.

2. The catalyst composition of claim 1, wherein the surface of the support is iron-free.

3. The catalyst composition of claim 1, wherein the support further comprises an element from Group IIA of the periodic table.

4. The catalyst composition of claim 3, wherein the element from Group IIA of the periodic table comprises magnesium.

5. The catalyst composition of claim 1, wherein the cobalt species comprises a cobalt oxide.

6. The catalyst composition of claim 1, wherein the cobalt species comprises less than 15% by weight of the catalyst composition.

7. The catalyst composition of claim 1, wherein the cobalt species comprises about 10% by weight of the catalyst composition.

8. The catalyst composition of claim 1, having a BET surface area of over 300 m²/g.

9. The catalyst composition of claim 1, having a pore volume of at least about 0.25 cc/g.

10. The catalyst composition of claim 1, configured to yield at least about 85% CNT from a carbon-containing source gas.

11. The catalyst composition of claim 1, configured to produce multi-wall CNTs.

12. The catalyst composition of claim 1, configured to produce CNT having a BET surface area of over 300 m²/g.

13. The catalyst composition of claim 1, configured to produce CNT having a pore volume of at least about 2 cc/g.

14. The catalyst composition of claim 1, configured to produce CNT having a bulk density of at least about 0.08 g/cc.

15. The catalyst composition of claim 1, configured to produce CNT having a diameter range of from about 8 nm to about 12 nm.

16. The catalyst composition of claim 1, configured to produce CNT having a G/D relative Raman intensity ratio of at least about 1 measured using a 638 am laser source and at least 0.9 measured using a 532 nm laser source.

17. The catalyst composition of claim 1, configured to produce CNT having lengths of at least about 10 microns.

18. A method for preparing a catalyst composition that comprises a support comprising alumina, and a cobalt species on a surface of the support, wherein the cobalt species is the sole active catalyst species for carbon nanotube (CNT) growth, the method comprising:
providing an aluminum hydroxide support precursor;
contacting the aluminum hydroxide support precursor with a solution that comprises at least a cobalt salt to create a paste; and
drying and calcining the paste to create the catalyst composition.

19. The method of claim 18, wherein the solution comprises a cobalt salt and a magnesium salt.

20. The method of claim 18, wherein the contacting step comprises mixing the aluminum hydroxide support precursor and the solution in a mixer.

21. The method of claim 18, wherein drying the paste comprises aging the paste at room temperature.

22. The method of claim 21, wherein drying the paste further comprises subjecting the aged paste to an elevated temperature for a number of hours to develop a dried paste.

23. The method of claim 22, wherein the calcining step comprises subjecting the dried paste to a temperature of at least about 400° C. for at least about 2 hours in air flow.

24. The method of claim 23, wherein the calcining step takes place at about 450° C.

25. The method of claim 18, having a Co:MgO:Al₂O₃ molar ratio composition of about 14:to about 1:to about 70, respectively.

26. The method of claim 18, further comprising size sorting the dried paste before the calcining step.

27. The method of claim 26, wherein the size sorting step comprises developing dried solid particles of at least about 100 microns.

28. The method of claim 27, wherein the dried solid particles are developed in a size range of from about 100 microns to about 300 microns.

29. The method of claim 18, wherein the aluminum hydroxide comprises one or more of gibbsite, bayerite, boehmite and those obtained by hydrolysis of aluminum alkoxides.
